(19) United States
(12) Patent Application Publication
(10) Pub. No.: US 2005/0243176 A1
(43) Pub. Date: Nov. 3, 2005

(54) Method of HDR image processing and manipulation

(76) Inventors: James Wu, Taoyuan (TW); Tsung-Wei Lin, Taipei (TW)

Correspondence Address: BIRCH STEWART KOLASCH & BIRCH, PO BOX 747, FALLS CHURCH, VA, 22040-0747, US

(21) Appl. No.: 10/834,881

(22) Filed: Apr. 30, 2004

(51) Int. Cl. H04N 5/225

(52) U.S. Cl. 348/207.1

(57) ABSTRACT

A method of HDR image processing and manipulation, including the steps of displaying a first control element for loading of multiple files containing pixel values of differently exposed LDR images, and metadata information including exposure times of the LDR images, displaying thumbnails of the LDR images sorted by the exposure times, displaying a second control element for automatic creation of a camera response function using the pixel values and the exposure times, displaying a first setting element for acquisition of an overall contrast and a set of values determining a first mapping function, and displaying a third control element for construction and displaying of an HDR radiance map by contrast reduction and tone mapping adjustment.

### BACKGROUND OF THE INVENTION

1. Field of the Invention

The present invention relates to HDR images and particularly to a method and graphical user interface for processing and manipulation of HDR images.

2. Description of the Prior Art

The “dynamic range” of a scene is the contrast ratio between its brightest and darkest parts. A plate of evenly-lit mashed potatoes outside on a cloudy day is low-dynamic range. The interior of an ornate cathedral with light streaming in through its stained-glass windows is high dynamic range. In fact, any scene in which the light sources can be seen directly is high dynamic range.

A High-Dynamic Range image is an image that has a greater dynamic range than can be shown on a standard display device, or that can be captured with a standard camera with just a single exposure.

HDR images also have the important property that their pixel values are proportional to the amount of light in the world corresponding to that pixel, unlike most regular images whose pixel values are nonlinearly encoded.

HDR Images are typically generated by combining multiple normal images of the same scene taken with different intensity levels, or as the result of creating a global illumination rendering. In practice, high dynamic range pixels use floating-point numbers, capable of representing light quantities of one to a million and beyond. Low-dynamic range images usually represent pixels using eight bits per channel, with pixel values ranging as integers between 0 and 255.

A typical software application for HDR image processing and manipulation is HDRShop developed by University of Southern California. HDRShop allows creation of a high-dynamic range image from a sequence of standard 24-bit images taken at different shutter speeds. The images should be taken without moving the camera, and should be bracketed so that the darkest parts of the scene are clearly visible in the longest exposure and the brightest parts of the image are not “blasted out” to white in the shortest exposure. Once the minimum and maximum exposure levels have been determined, an exposure interval is chosen. The interval depends on many things, in particular how well the camera's response curve is calibrated. If the response curve isn't known, the images in the sequence must be taken close to each other, for example 1 stop apart for calibration of the curve. Once the camera's curve has been well calibrated, the sequence can be taken further apart, at 3 stops.

FIG. 1 shows the user interface of HDRShop for assembling an HDR image from LDR (low-dynamic range) sequence. By clicking the “Load Images” button and selecting the entire sequence of images from the file selector, the LDR image sequence are loaded. The image file names appear in the worksheet in the dialog box. The images in the worksheet should be in order from shortest exposure to longest exposure. HDRShop will automatically sort the images based on the average brightness of the pixels in each image. This brightness is displayed in the “sort” column. The response curve of the camera that generated these images is specified by clicking the “Change” button for curve selection. HDRShop should know which images were taken at which exposure settings. These values can be specified per color channel, or for the entire image. For most applications, the relative exposure levels of the different color channels will be the same. In the “Select Channels” area, the “R=G=B” button should be selected. If a single color channel is selected, then the values entered in the worksheet will only apply to the currently selected color channel. The relative exposure values of the images in the sequence are figured out by clicking the “Calculate” button in the “Calculate Scale Increments”. However, the calculation successes only if the images are taken very close together and the camera curve is known. Usually, the relative exposure values of the images in the sequence are acquired from the user. F-stop increment is selected by clicking an appropriate button in the “Use Preset Scale Increments” area. Finally, the images are compiled into a single HDR image by clicking the “Generate Image” button.

HDRShop, however, has many drawbacks. First, the LDR sequence is shown by the worksheet listing the file names and attributes of the images rather than displaying the images, which makes identifying unsatisfying images to be removed from the sequence inconvenient. Second, the images are not registered before assemble, which easily blurs the resulting image due to subtle camera movement. Third, manual calibration of camera response curve, input of the exposure values and cropping of the resulting image is tedious. Fourth, HDRShop does not allow optimization of displayed HDR images.

### SUMMARY OF THE INVENTION

The object of the present invention is to provide a more powerful and user-friendly software application for HDR image processing and manipulation.

The present invention provides a method of HDR image processing and manipulation using an LDR display, including the steps of displaying a first control element which allows loading of a plurality of files containing pixel values of differently exposed LDR images, and metadata information including exposure times of the LDR images, displaying thumbnails of the LDR images sorted by the exposure times thereof, displaying a second control element which allows automatic creation of a camera response function using the pixel values and the exposure times stored in the loaded files, displaying a first setting element which allows acquisition of an overall contrast and a set of values determining a first mapping function, and displaying a third control element which allows construction of an HDR radiance map using the camera response function, and the pixel values and exposure times stored in the loaded files, and displaying of the HDR radiance map on the LDR display device by reduction of the HDR radiance map to the overall contrast based on decomposition of the HDR radiance map into base and detail layers, and applying the first mapping function to the detail layer.

The present invention further provides a graphical user interface of a software application for HDR image processing and manipulation on an LDR display. The graphical user interface includes a first control element which allows loading of a plurality of files containing pixel values of differently exposed LDR images, and metadata information including exposure times of the LDR images, a first area in which thumbnails of the LDR images sorted by the exposure times thereof are displayed, a second control element which allows automatic creation of a camera response function using the pixel values and the exposure times stored in the loaded files, a first setting element which allows acquisition of an overall contrast and a set of values determining a first mapping function, and a third control element which allows construction of an HDR radiance map using the camera response function, and the pixel values and exposure times stored in the loaded files, and displaying of the HDR radiance map on the LDR display device by reduction of the HDR radiance map to the overall contrast based on decomposition of the HDR radiance map into a base and detail layer, and applying the first mapping function to the detail layer.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows the HDRShop user interface for assembling an HDR image from an LDR (low-dynamic range) sequence.

FIG. 2 shows the architecture of the software application for HDR image processing and manipulation according to one embodiment of the invention.

FIGS. 3, 4A, 4B and 5 show the graphical user interface of the software application according to one embodiment of the invention.

FIG. 6 show a flowchart of a method for image cropping according to one embodiment of the invention.

FIG. 7A˜7D respectively show four LDR images captured using different exposure times by a camera aimed at a cross with subtle movement.

FIG. 8 shows the alignment of the four transformed results of the LDR images in FIGS. 7A˜7D.

FIG. 9 shows a mask created to determine the cropping rectangle for the registration result of the LDR images shown in FIGS. 7A˜7D.

FIG. 10A˜10D show four scanning sequences of the auto-cropping function according to one embodiment of the invention.

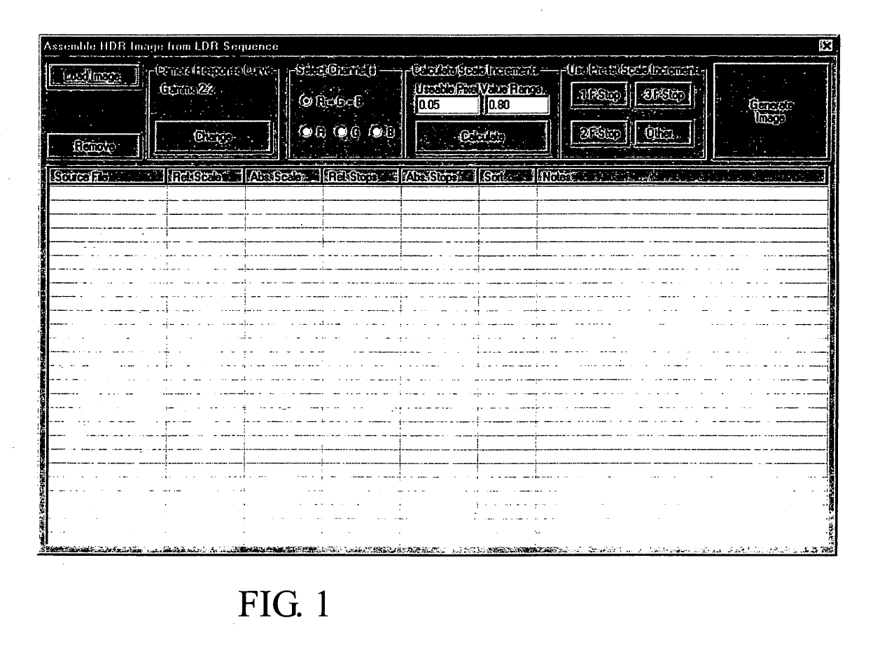

### DETAILED DESCRIPTION OF THE INVENTION

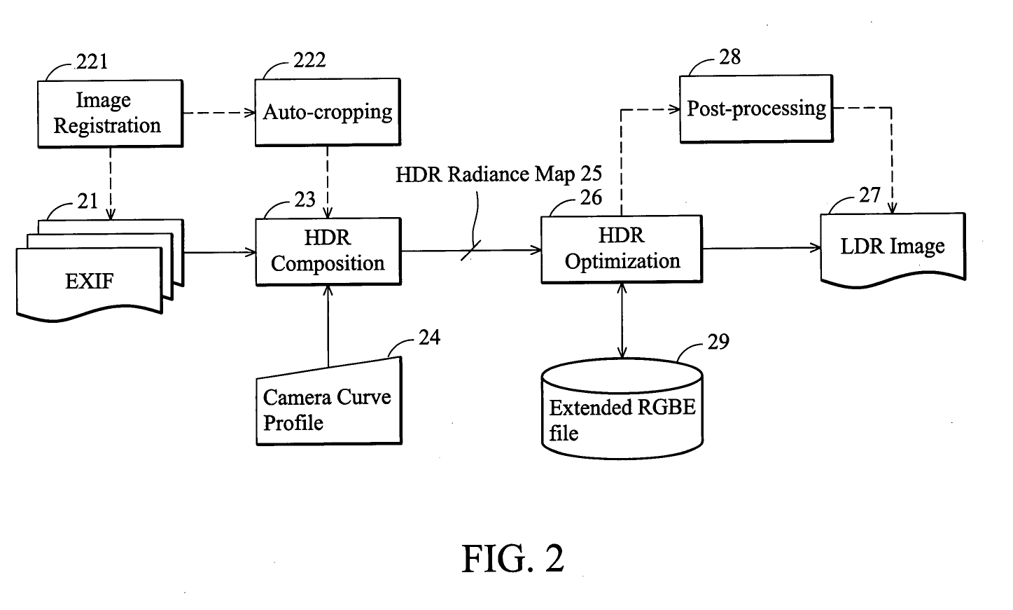

FIG. 2 shows the architecture of the software application for HDR image processing and manipulation according to one embodiment of the invention.

Multiple LDR images with different exposures of a scene are captured by a digital camera. For each shot, the pixel values and metadata information including the exposure time, and the date and time the image was captured are stored in a file 21. The files 21 are then loaded into the software application.

Before creation of the high dynamic range radiance map, two optional steps of image registration 221 and auto-cropping 222 cab be performed.

The image registration is actually a geometric transformation. Transformation matrices for the LDR images are identified thereby. The LDR images are aligned with each other by transforming the pixel coordinates using the transformation matrices, which prevents the result from being blurred due to subtle camera movement. Currently, in all image processing software applications, registration is based on the manual selection of ground control points. However, an FFT-based image registration is employed in this embodiment, such as that disclosed by B. S. Reddy and B. N. Chatterji, “An FFT-based technique for translation, rotation and scale-invariant image registration”, IEEE Trans. On Image Processing, Vol. 5, No. 8, 1996, pp. 1266-1271. Thus, image registration in this case is automatic.

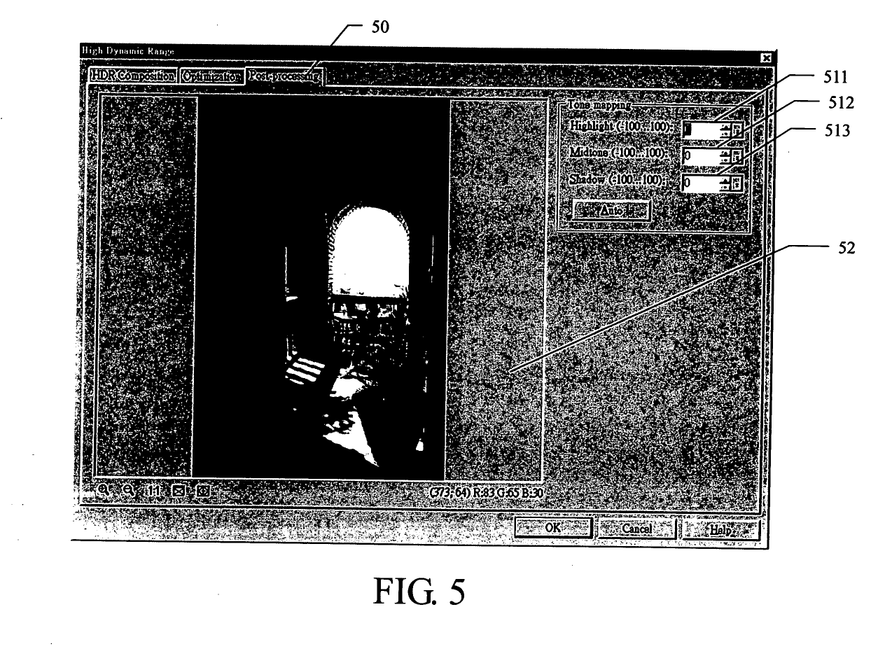

The auto-cropping function determines a cropping rectangle for the LDR images. FIG. 6 shows a flowchart of a method thereof.

In step 61, the transformation matrices derived by image registration are applied to the LDR images.

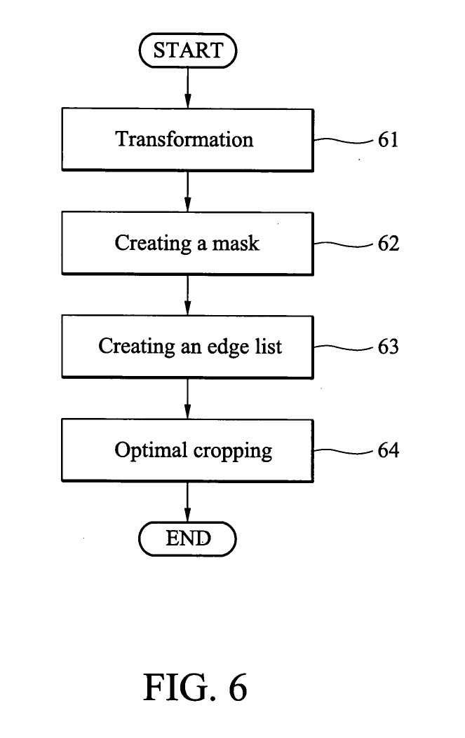

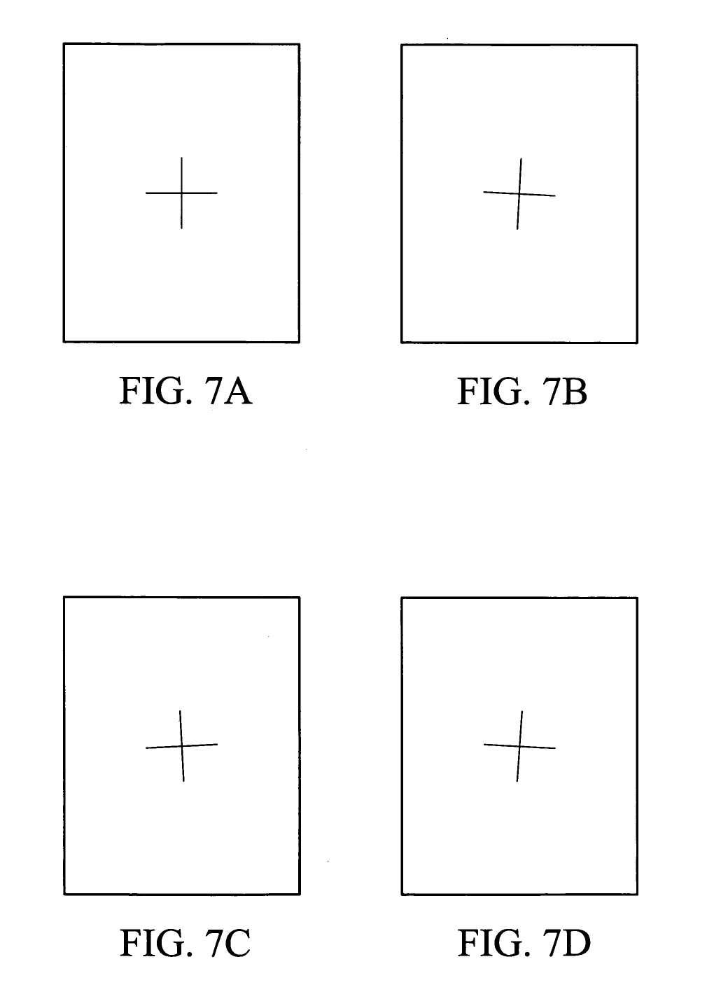

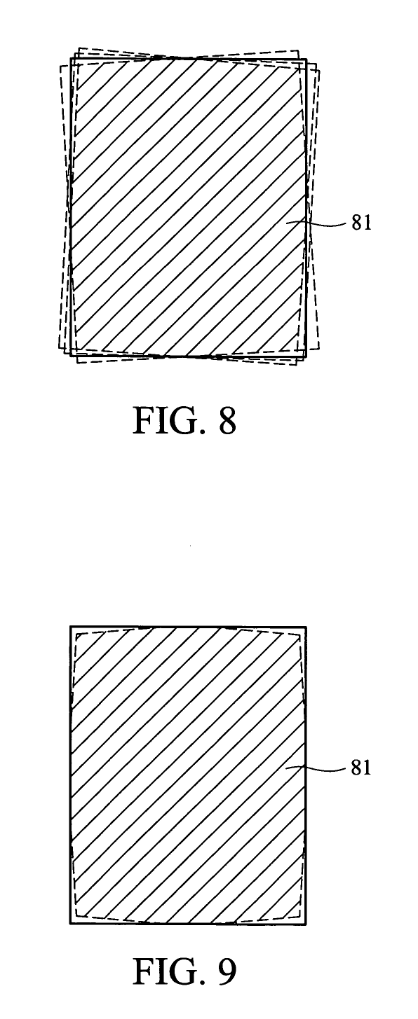

In step 62, a mask is created and has columns and rows with the same dimensions as the LDR images. The mask distinguishes a region composed of a pixel conjunction of all transformed pixel sets of the LDR images. FIGS. 7A˜7D respectively show four LDR images 71˜74 captured by a camera aimed at a cross using different exposure times, wherein the crosses in the LDR images 72˜74 are results of rotations of the cross in the LDR image 71 due to subtle camera movement. FIG. 8 shows the alignment of the four transformed results of the LDR images 71˜74. It is noted that a region 81 is composed of a conjunction of the pixels of the four transformed LDR images. FIG. 9 shows the corresponding mask, which has the same dimensions as each LDR image, and the pixel in the mask has a value of zero if it is an element of the pixel conjunction (in the region 81); otherwise (outside the region 81), the pixel value is not zero.

In step 63, an edge list is created. The edge list is a one-dimensioned array with a length the same as the height (number of the rows) of the mask and records the column indices of the left and right boundary pixels of each row of the region 81 in the mask.

In step 64, an optimal cropping function is applied to the edge list to derive two corners for determining the cropping rectangle.

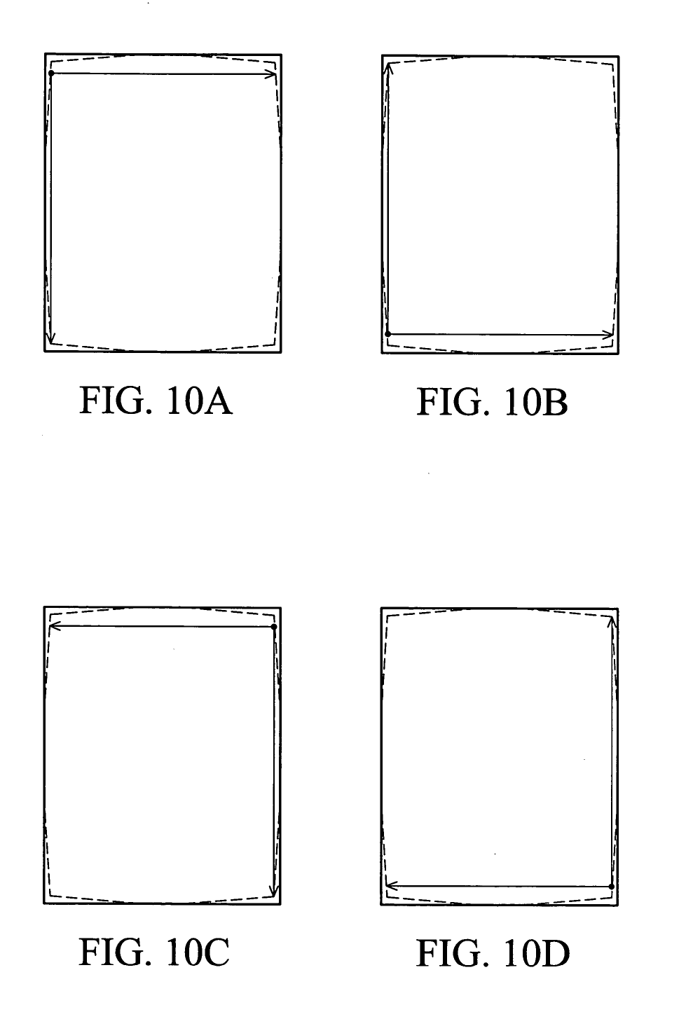

First, as shown in FIG. 10A, in a sequence from top to bottom, for each row, a width between the left and right boundary pixel of the row and a height between the left boundary pixel and a bottom boundary pixel of the same column are calculated using the edge list. The product of the width and height is also derived. By comparing all the product, the largest is determined.

Second, as shown in FIG. 10B, in a sequence from bottom to top, for each row, a width between the left and right boundary pixel of the row and a height between the left boundary pixel and a top boundary pixel of the same column are calculated using the edge list. The product of the width and height is also derived. By comparing all the products, the largest is determined. Then, the two largest products derived in the two opposite row sequences for the left boundary pixels are compared to identify a top-left corner of the cropping rectangle. The left boundary pixel of the row having the larger one is the top-left corner.

Third, as shown in FIG. 10C, in a sequence from top to bottom, for each row, a width between the left and right boundary pixel of the row and a height between the right boundary pixel and a bottom boundary pixel of the same column are calculated using the edge list. The product of the width and height is also derived. By comparing all the products, the largest is determined.

Fourth, as shown in FIG. 10D, in a sequence from bottom to top, for each row, a width between the left and right boundary pixel of the row and a height between the right boundary pixel and a top boundary pixel of the same column are calculated using the edge list. The product of the width and height is also derived. By comparing all the products, the largest is determined. Then, the two largest products derived in the two opposite row sequences for the right boundary pixels are compared to identify a bottom-right corner of the cropping rectangle. The right boundary pixel of the row having the larger product is the bottom-right corner. Thus, the cropping rectangle is determined.

In HDR composition 23, a camera curve profile (response function) 24 is created using the pixel values and the exposure times stored in the loaded files 21. By the camera response function 24, and the pixel values of the LDR images (to which the transformation matrices and cropping rectangle are applied, if the image registration and auto-cropping steps 221 and 222 are selected) and exposure times stored in the files 21, the radiance value of each pixel is computed to construct an HDR radiance map 25. The method for creation of the response function 24 and construction of the HDR radiance map 25 is preferably that disclosed by P. Debevec and J. Malik, “Recovering high dynamic range radiance maps from photographs”, Proceedings of SIGGRAPH 97, 1997, pp. 369-378.

In HDR optimization 26, the HDR radiance map 25 is displayed on an LDR media (the monitor) in an optimization or viewing mode.

In the optimization mode, a method for contrast reduction is first implemented, such as one disclosed by F. Durand and J. Dorsey, “Fast bilateral filtering for the display of high dynamic range images”, ACM Transactions on Graphics (TOG), Vol. 21, No. 3, 2002, pp. 257-266. The method is based on a two-scale decomposition of the HDR radiance map 25 into a base layer, encoding large-scale variations, and a detail layer. Only the base layer has its contrast reduced, thereby preserving detail. The base layer is obtained using an edge-preserving filter called the bilateral filter. This is a non-linear filter, where the weight of each pixel is computed using a Gaussian in the spatial domain multiplied by an influence function in the intensity domain that decreases the weight of pixels with large intensity differences. The bilateral filtering is accelerated by using a piecewise-linear approximation in the intensity domain and appropriate sub-sampling. An overall contrast for the contrast reduction is user-controllable. Second, a Highlight/Mid-tone/Shadow function of the base layer is applied to the detail layer, which allows tone mapping adjustment thereof. Values of highlight, mid-tone and shadow determining the mapping function are also user-controllable. Finally, after the contrast reduction and tone mapping adjustment, the base and detail layers are composed to form an LDR image 27.

In the viewing mode, a mapping function is applied to the HDR radiance map 25 for contrast reduction. When the HDR radiance map 25 is displayed, only pixels having radiance values within a selected radiance range are properly displayed, and all the other pixels having radiance values above and below the selected range are respectively saturated and cut off.

Additionally, an extended RGBE file 29 is created for storage of the HDR radiance map 25. Compared to a standard RGBE file format including a header and body of the HDR radiance map 25, the extended RGBE file 29 further includes a body of the base layer attached to the body of the HDR radiance map 25, and a line, read as “WITH THE BASE LAYER”, inserted into the header to indicate the attachment of the base layer. Software applications handling the standard RGBE files also cope with the extended RGBE files since the base layer information can be ignored. The extended RGBE file offers the advantage of fast LDR image reproduct. The LDR image 27 is reproduced without decomposition of the HDR radiance map 25 since the base layer information is available.

Another optional step of post-processing 28, wherein another Highlight/Mid-tone/Shadow mapping function determined by user-controllable highlight, mid-tone and shadow values is applied to the LDR image 27 for tone mapping adjustment, can be performed.

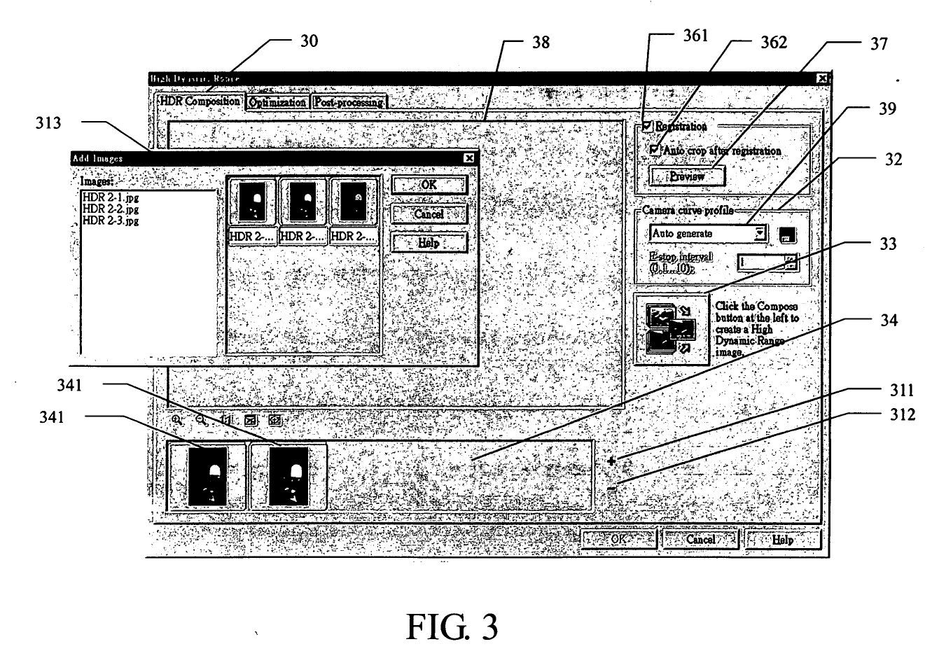

FIGS. 3, 4A, 4B and 5 show the graphical user interface of the software application according to the previous embodiment.

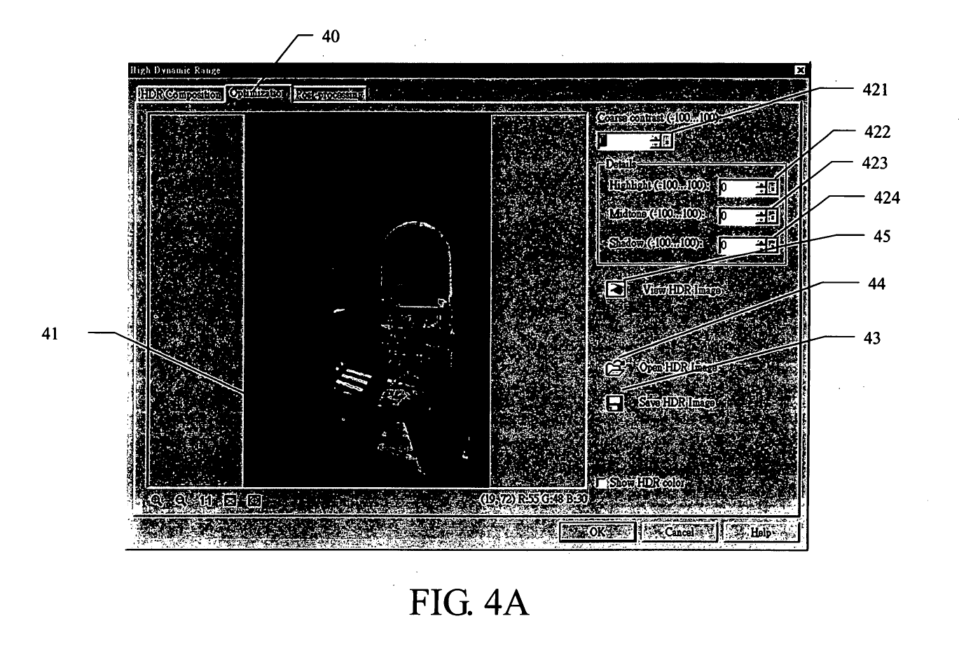

FIG. 3 shows a page 30 labeled “HDR Composition”. A button 311 allows adding of the LDR image files 21 (shown in FIG. 2) into the LDR image sequence. A window 313 appears by clicking the button 311 for selection of the LDR image files to be added. Thumbnails 341 of the LDR images in the sequence are displayed in the area 34 and sorted by exposure time. A button 312 allows removing of the LDR image files with their thumbnails selected from the sequence. Check boxes 361 and 362 determine whether only the image registration 221 or a combination of image registration 221 and auto-cropping 222 (show in FIG. 2) is implemented. The image registration or combination result thereof is displayed in the area 38 by clicking a button 37. A selection box 39 in a “Camera curve profile” area 32 determines whether the camera response function 24 (shown in FIG. 2) should be automatically created by the information stored in the files 21 (shown in FIG. 2). By clicking a button 33, the HDR radiance map 25 is created and the page is switched to another one labeled “Optimization” (shown in FIG. 4A) having an area 41 in which the LDR image 27 (shown in FIG. 2) is displayed by a default overall contrast, highlight, mid-tone and shadow values (0).

FIG. 4A shows the page 40 labeled “Optimization” in the optimization mode. There are four setting boxes 421˜424 respectively allowing adjustment of the overall contrast for the contrast reduction, and highlight, mid-tone and shadow values for detail layer tone mapping. The extended RGBE file 29 (shown in FIG. 2) is stored by clicking a button 43. A button 44 allows loading of an existing standard or extended RGBE file containing an HDR radiance map to be displayed in the area 41. By clicking a button 45, the page 40 is switched to the viewing mode, wherein the LDR image 27 displayed in the area 41 is replaced by a resulting image of the viewing mode with a default radiance range (0) and the setting boxes 421˜424 are replaced by a slider 46 for adjustment of the radiance range, as shown in FIG. 4B.

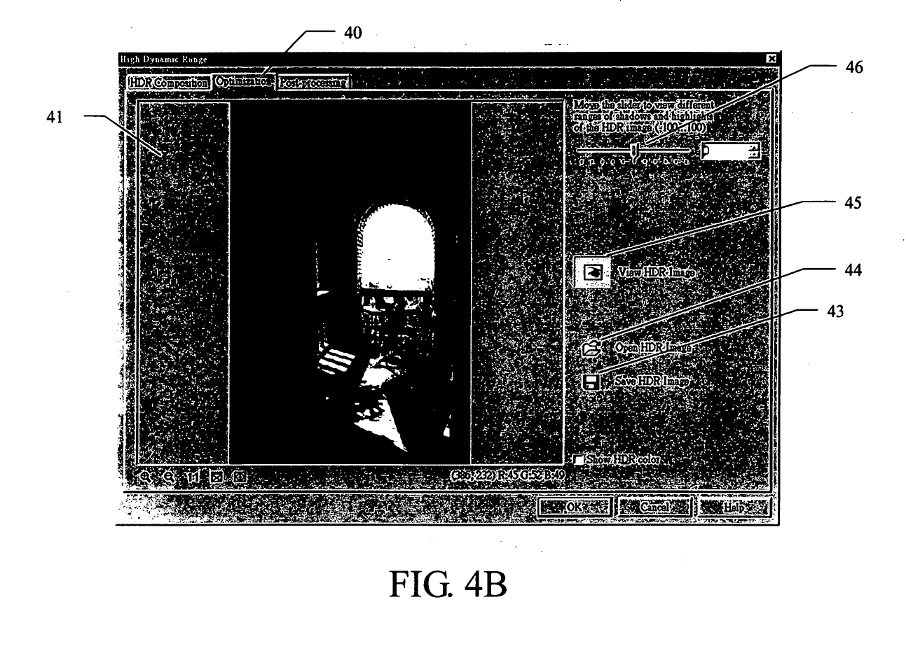

FIG. 5 shows a page 50 labeled “Post-processing”. There are three setting boxes 511˜513 respectively allowing adjustment of the highlight, mid-tone and shadow values of the mapping function applied to the optimized LDR image 27. The result is displayed in the area 52.

In conclusion, the present invention provides a more powerful and user-friendly software application for HDR image processing and manipulation. The key features of the application are a user friendly GUI, automatic image registration and cropping, optimization of HDR reduction, and HDR image storage by extended RGBE files.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A method of HDR image processing and manipulation using an LDR display, comprising the steps of:
displaying a first control element which allows adding into a sequence a plurality of files containing pixel values of differently exposed LDR images, and metadata information including exposure times of the LDR images;
displaying thumbnails of the LDR images sorted by the exposure times thereof;
displaying a second control element which allows automatic creation of a camera response function using the pixel values and the exposure times stored in the loaded files;
displaying a first setting element which allows acquisition of an overall contrast and a set of values determining a first mapping function; and
displaying a third control element which allows:
construction of an HDR radiance map using the camera response function, and the pixel values and exposure times stored in the loaded files; and
displaying the HDR radiance map on the LDR display device by reduction of the HDR radiance map to the overall contrast based on decomposition of the HDR radiance map into a base and detail layer, and applying the first mapping function to the detail layer.

2. The method as claimed in claim 1, wherein the first and third control elements are buttons.

3. The method as claimed in claim 1, wherein the format of the loaded files is EXIF.

4. The method as claimed in claim 1, wherein the second control element is a check box.

5. The method as claimed in claim 1, wherein the first setting element comprises four setting boxes respectively for the overall contrast, and a highlight, mid-tone and shadow value.

6. The method as claimed in claim 1 further comprising the step of:
displaying a fourth control element which allows removing the files from the sequence.

7. The method as claimed in claim 6, wherein the fifth control element is a button.

8. The method as claimed in claim 1 further comprising the step of:
displaying a fifth control element which allows saving of the HDR radiance map.

9. The method as claimed in claim 8, wherein the fourth control element is a button.

10. The method as claimed in claim 8, wherein an extended RGBE file containing information of the HDR radiance map and the base layer is created by saving the HDR radiance map.

11. The method as claimed in claim 10, wherein the extended RGBE file comprises:
a header containing header information of the HDR radiance map;
a first body containing radiance values of the HDR radiance map;
a second body attached to the first body and containing radiance values of the base layer; and
a text line inserted into the header to indicate the attachment of the second body.

12. The method as claimed in claim 1 further comprising the steps of:
displaying a sixth control element which allows displaying of the HDR radiance map by saturating and cutting off pixels having radiance values above and below a particular radiance range of the HDR radiance map; and
displaying a seventh control element which allows adjustment of the radiance range.

13. The method as claimed in claim 12, wherein the sixth control element is a button and the seventh control element is a slider.

14. The method as claimed in claim 1 further comprising the step of:
displaying an eighth control element which allows FFT-based image registration of the LDR images.

15. The method as claimed in claim 14 further comprising the step of:
displaying a ninth control element which allows automatic cropping of the image registration result.

16. The method as claimed in claim 15, wherein the eighth and ninth control elements are check boxes.

17. The method as claimed in claim 15, wherein transformation matrices for the LDR images are identified by the image registration, and a cropping rectangle is determined by the automatic cropping comprising the steps of:
applying the transformation matrices to the LDR images;
creating a mask having columns and rows with the same dimensions as the LDR images, and distinguishing a region composed of a pixel conjunction of all transformed pixel sets of the LDR images;
within the region, for each of the rows, calculating a width between a first and second boundary pixel of the row, a first height between the first and a third boundary pixel of the same column, a second height between the first and a fourth boundary pixel of the same column, a third height between the second and a fifth boundary pixel of the same column, a fourth height between the second and a sixth boundary pixel of the same column, two first products respectively of the width and the first height, and the width and the second height, and two second products of the width and the third height, and the width and the fourth height; and
identifying one of the first boundary pixels as a first corner of the cropping rectangle, and one of the second boundary pixel as a second corner of the cropping rectangle, wherein one of the first products calculated for the row of the first corner is the largest first product and one of the second products calculated for the row of the second corner is the largest second product.

18. The method as claimed in claim 17, wherein the first boundary pixel of each row is a left boundary pixel.

19. The method as claimed in claim 17, wherein the second boundary pixel of each row is a right boundary pixel.

20. The method as claimed in claim 17, wherein the third and fifth boundary pixels of the columns are bottom boundary pixels.

21. The method as claimed in claim 17, wherein the fourth and sixth boundary pixels of the columns are bottom boundary pixels.

22. The method as claimed in claim 17, wherein the calculation of the first products of the widths and first heights are implemented for the rows in a sequence from top to bottom.

23. The method as claimed in claim 17, wherein the calculation of the first products of the widths and second heights are implemented for the rows in a sequence from bottom to top.

24. The method as claimed in claim 17, wherein the calculation of the second products of the widths and third heights are implemented for the rows in a sequence from top to bottom.

25. The method as claimed in claim 17, wherein the calculation of the second products of the widths and fourth heights are implemented for the rows in a sequence from bottom to top.

26. The method as claimed in claim 15 further comprising the step of:
displaying a tenth control element which allows display of the image registration result or a combination of image registration and automatic cropping result thereof.

27. The method as claimed in claim 26, wherein the tenth control element is a button.

28. The method as claimed in claim 1 further comprising the step of:
displaying a second setting element which allows acquisition of a set of values determining a second mapping function applied to the displaying result of the HDR radiance map.

29. The method as claimed in claim 28, wherein the second setting element comprises three setting boxes respectively for a highlight, mid-tone and shadow values.

30. A graphical user interface of a software application for HDR image processing and manipulation on an LDR display, the graphical user interface comprising:
a first control element which allows adding into a sequence a plurality of files containing pixel values of differently exposed LDR images, and metadata information including exposure times of the LDR images;
a first area in which thumbnails of the LDR images sorted by the exposure times thereof are displayed;
a second control element which allows automatic creation of a camera response function using the pixel values and the exposure times stored in the loaded files;
a first setting element which allows acquisition of an overall contrast and a set of values determining a first mapping function; and
a third control element which allows:
construction of an HDR radiance map using the camera response function, and the pixel values and exposure times stored in the loaded files; and
displaying of the HDR radiance map on the LDR display device by reduction of the HDR radiance map to the overall contrast based on decomposition of the HDR radiance map into a base and detail layer, and applying the first mapping function to the detail layer.

31. The graphical user interface as claimed in claim 30, wherein the first and third control element are buttons.

32. The graphical user interface as claimed in claim 30, wherein the format of the loaded files is EXIF.

33. The graphical user interface as claimed in claim 30, wherein the second control element is a check box.

34. The graphical user interface as claimed in claim 30, wherein the first setting element comprises four setting boxes respectively for the overall contrast, and a highlight, mid-tone and shadow value.

35. The graphical user interface as claimed in claim 30 further comprising:
a fourth control element which allows removing the loaded files from the sequence.

36. The graphical user interface as claimed in claim 35, wherein the fifth control element is a button.

37. The graphical user interface as claimed in claim 30 further comprising:
a fifth control element which allows saving of the HDR radiance map.

38. The graphical user interface as claimed in claim 37, wherein the fourth control element is a button.

39. The graphical user interface as claimed in claim 37, wherein an extended RGBE file containing information of the HDR radiance map and the base layer is created by saving the HDR radiance map.

40. The graphical user interface as claimed in claim 39, wherein the extended RGBE file comprises:
a header containing header information of the HDR radiance map;
a first body containing radiance values of the HDR radiance map;
a second body attached to the first body and containing radiance values of the base layer; and
a text line inserted into the header to indicate the attachment of the second body.

41. The graphical user interface as claimed in claim 30 further comprising:
a sixth control element which allows displaying of the HDR radiance map by respectively saturating and cutting off pixels having radiance values above and below a particular radiance range of the HDR radiance map; and
a seventh control element which allows adjustment of the radiance range.

42. The graphical user interface as claimed in claim 41, wherein the sixth control element is a button and the seventh control element is a slider.

43. The graphical user interface as claimed in claim 30 further comprising:
an eighth control element which allows FFT-based image registration of the LDR images.

44. The graphical user interface as claimed in claim 43 further comprising:
a ninth control element which allows automatic cropping of the image registration result.

45. The graphical user interface as claimed in claim 44, wherein the eighth and ninth control elements are check boxes.

46. The graphical user interface as claimed in claim 44, wherein transformation matrices for the LDR images are identified by the image registration, and a cropping rectangle is determined by the automatic cropping comprising the steps of:
applying the transformation matrices to the LDR images;
creating a mask having columns and rows with the same dimensions as the LDR images, and distinguishing a region composed of a pixel conjunction of all transformed pixel sets of the LDR images;
within the region, for each of the rows, calculating a width between a first and second boundary pixel of the row, a first height between the first and a third boundary pixel of the same column, a second height between the first and a fourth boundary pixel of the same column, a third height between the second and a fifth boundary pixel of the same column, a fourth height between the second and a sixth boundary pixel of the same column, two first products respectively of the width and the first height, and the width and the second height, and two second products of the width and the third height, and the width and the fourth height; and
identifying one of the first boundary pixels as a first corner of the cropping rectangle, and one of the second boundary pixel as a second corner of the cropping rectangle, wherein one of the first products calculated for the row of the first corner is the largest first product and one of the second products calculated for the row of the second corner is the largest second product.

47. The graphical user interface as claimed in claim 46, wherein the first boundary pixel of each row is a left boundary pixel.

48. The graphical user interface as claimed in claim 46, wherein the second boundary pixel of each row is a right boundary pixel.

49. The graphical user interface as claimed in claim 46, wherein the third and fifth boundary pixels of the columns are bottom boundary pixels.

50. The graphical user interface as claimed in claim 46, wherein the fourth and sixth boundary pixels of the columns are bottom boundary pixels.

51. The graphical user interface as claimed in claim 46, wherein the calculation of the first products of the widths and first heights are implemented for the rows in a sequence from top to bottom.

52. The graphical user interface as claimed in claim 46, wherein the calculation of the first products of the widths and second heights are implemented for the rows in a sequence from bottom to top.

53. The graphical user interface as claimed in claim 46, wherein the calculation of the second products of the widths and third heights are implemented for the rows in a sequence from top to bottom.

54. The graphical user interface as claimed in claim 46, wherein the calculation of the second products of the widths and fourth heights are implemented for the rows in a sequence from bottom to top.

55. The graphical user interface as claimed in claim 44 further comprising:
a tenth control element which allows displaying of the image registration result, the automatic cropping result or a combination result thereof.

56. The graphical user interface as claimed in claim 55, wherein the tenth control element is a button.

57. The graphical user interface as claimed in claim 30 further comprising:
a second setting element which allows acquisition of a set of values determining a second mapping function applied to the displayed result of the HDR radiance map.

58. The graphical user interface as claimed in claim 57, wherein the second setting element comprises three setting boxes respectively for a highlight, mid-tone and shadow values.
